(19) United States
(12) Patent Application Publication
(10) Pub. No.: US 2014/0060882 A1
(43) Pub. Date: Mar. 6, 2014

(54) COMMUNICATION CABLE HAVING AT LEAST ONE INSULATED CONDUCTOR

(71) Applicants: Kenneth William Ellis, Etters, PA (US); Julia Anne Lachman, York, PA (US); Eric Douglas Springston, II, Hershey, PA (US)

(72) Inventors: Kenneth William Ellis, Etters, PA (US); Julia Anne Lachman, York, PA (US); Eric Douglas Springston, II, Hershey, PA (US)

(73) Assignee: Tyco Electronics Corporation, Berwyn, PA (US)

(21) Appl. No.: 13/600,551

(22) Filed: Aug. 31, 2012

(51) Int. Cl. H02G 15/08; H01B 11/00

(52) U.S. Cl. 174/78; 174/113 R

(57) ABSTRACT

A communication cable including a cable jacket having a jacket end and a shielding layer having an electrically conductive exterior surface. The exterior surface extends along a length of the communication cable and interfaces with the cable jacket. The exterior surface has an exposed section that extends beyond the jacket end to a shielding end of the shielding layer. The communication cable also includes at least one insulated conductor that extends along the length of the communication cable and that is surrounded by the shielding layer and the cable jacket. The communication cable also includes an adhesive layer that surrounds the exposed section of the exterior surface. The adhesive layer is electrically conductive and is in intimate contact with the exterior surface.

### BACKGROUND

The subject matter herein relates generally to a communication cable having at least one insulated conductor that is configured to electrically interconnect different electrical components.

For at least some types of communication cables, the communication cable includes at least one insulated conductor and a drain wire (also referred to as a grounding wire) that extend alongside each other for the length of the communication cable. The insulated conductor(s) and the drain wire may be surrounded by a shielding layer that, in turn, is surrounded by a cable jacket. The shielding layer includes a conductive foil that, along with the drain wire, functions to shield the insulated conductor(s) from electromagnetic interference (EMI) and generally improve performance. The communication cables may have a foil-in configuration, wherein the conductive foil faces radially inward, or a foil-out configuration, wherein the conductive foil faces radially outward. At the terminating ends of the communication cable, the cable jacket, the shielding layer, and the insulation that covers the conductor(s) may be removed (e.g., stripped) to expose the conductor(s). The drain wire and the exposed conductor(s) may then be mechanically and electrically coupled (e.g., soldered, crimped, welded, and the like, or coupled using an insulation displacement connector (IDC)) to corresponding elements of an electrical component, such as an electrical connector.

However, the above communication cable may have some undesirable qualities, particularly when the communication cable is used for high speed applications (e.g., greater than 10 Gbps). For example, when attempting to terminate the drain wire to the electrical connector assembly shell in a foil-in configuration, the conductive foil at the terminating end of the communication cable may be cut or torn in order to expose the drain wire to connect to it. The resulting seam in the foil may increase electromagnetic radiation emission/susceptibility at the terminating end. The resulting interruption in the conductive foil may also cause an unwanted change in impedance at the terminating end. In some cases, a foil-out configuration may avoid disturbing the foil shielding; however, this configuration may still have other drawbacks.

Each of the foil-in and foil-out cables may cause a “choke point” in which the ground path reduces from a 360 degree path surrounding the cable length to a small contact area at the drain wire connection, and then expands to the 360 degree path surrounding the connector assembly shielding shell. Each of the foil-in and foil-out cables may alter the impedance of the cable at tight bend areas where the drain wire may resist stretching and encroach on the signal conductors. Lastly, a drain wire may increase the cost of the cable and may also add complexity to the manufacturing process.

Accordingly, there is a need for a communication cable that provides effective EMI shielding at relatively low cost.

### BRIEF DESCRIPTION

In one embodiment, a communication cable is provided that includes a cable jacket having a jacket end and a shielding layer having an electrically conductive exterior surface. The exterior surface extends along a length of the communication cable and interfaces with the cable jacket. The exterior surface has an exposed section that extends beyond the jacket end to a shielding end of the shielding layer. The communication cable also includes at least one insulated conductor that extends along the length of the communication cable and that is surrounded by the shielding layer and the cable jacket. The communication cable also includes an adhesive layer that surrounds the exposed section of the exterior surface. The adhesive layer is electrically conductive and is in intimate contact with the exterior surface.

In another embodiment, a communication cable is provided that includes a cable jacket having a jacket end and a shielding layer having an electrically conductive exterior surface. The exterior surface extends along a length of the communication cable and interfaces with the cable jacket. The exterior surface has an exposed section that extends beyond the jacket end to a shielding end of the shielding layer. The communication cable also includes at least one insulated conductor that extends along the length of the communication cable and that is surrounded by the shielding layer and the cable jacket. The communication cable does not include a drain wire that extends along the at least one insulated conductor. The shielding layer is configured to be electrically grounded at the exposed section.

In some embodiments, the communication cable may include a plurality of insulated conductors (e.g., one or more pairs). In particular embodiments, a pair of insulated conductors constitute a parallel pair of insulated conductors.

In yet another embodiment, an electrical connector assembly is provided that includes an electrical connector having signal conductors and a communication cable coupled to the electrical connector. The communication cable includes insulated conductors extending along a length of the communication cable. The insulated conductors are electrically coupled to corresponding signal conductors (e.g., contacts, terminals, and the like). The communication cable also includes a shielding layer that surrounds the insulated conductors and has an electrically conductive exterior surface that extends along the length of the cable. The communication cable also includes an adhesive layer that surrounds and is in intimate contact with the exterior surface of the shielding layer. The adhesive layer is electrically conductive. The connector assembly also includes a ground shield that is shaped to surround the adhesive layer. The ground shield electrically couples the exterior surface of the shielding layer to the electrical connector such that a grounding pathway exists through the ground shield.

### BRIEF DESCRIPTION OF THE DRAWINGS

FIG. 1 is a perspective view of a terminating end of a communication cable formed in accordance with one embodiment.

FIG. 2 is a perspective view of the communication cable of FIG. 1 in which a portion of a cable jacket has been removed to expose a shielding layer.

FIG. 3 is a perspective view of the communication cable of FIG. 1 having an adhesive layer applied to the exposed shielding layer.

FIG. 4 is a perspective view of the communication cable of FIG. 1 as a ground shield is coupled to the adhesive layer.

FIG. 5 is an enlarged view of the communication of cable after the ground shield has been coupled to the adhesive layer.

FIG. 6 is a perspective view of an electrical connector assembly formed in accordance with one embodiment.

FIG. 7 is a perspective view of a portion of an electrical connector assembly formed in accordance with one embodiment.

### DETAILED DESCRIPTION

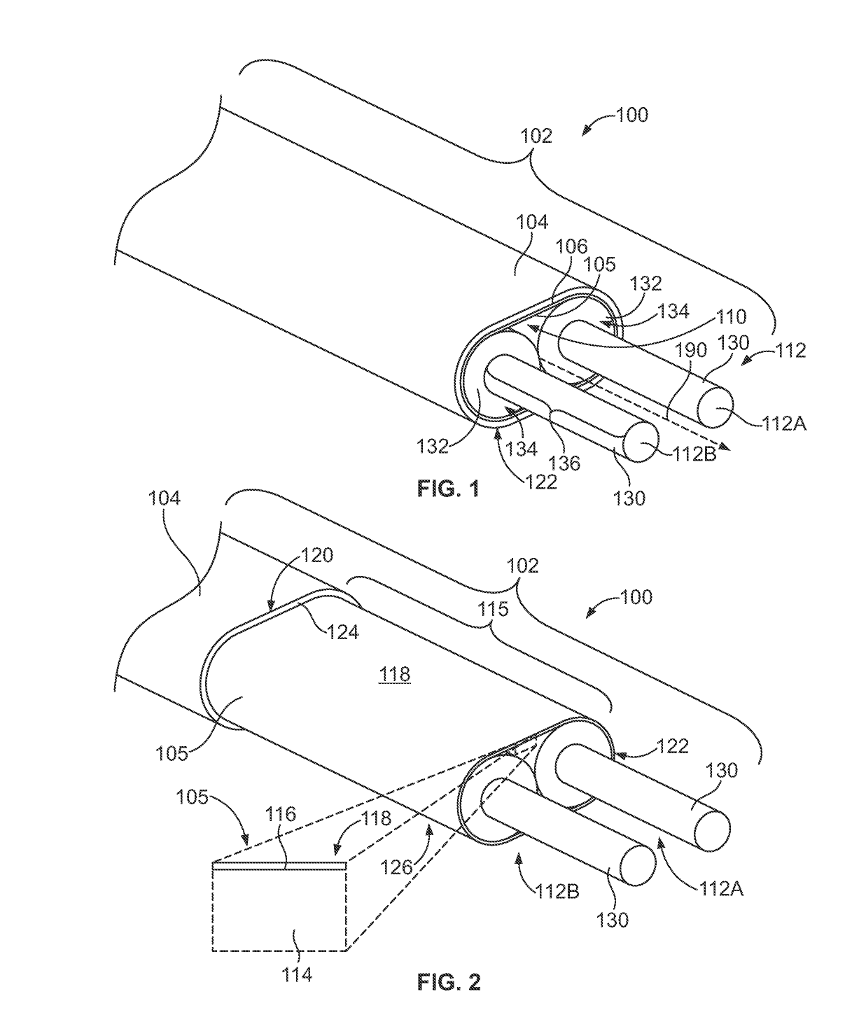

FIGS. 1-5 illustrate a communication cable 100 formed in accordance with one embodiment at different stages of manufacture. FIG. 1 is a perspective view of a portion of the communication cable that includes a terminating end 102. The communication cable 100 is a flexible cable that electrically interconnects two electrical components, which may be, for example, electrical connectors, communication devices, and the like. The communication cable 100 may be configured to transmit data signals at a high data rate or speed (e.g., 10 Gbps or more). As shown, the communication cable 100 may include multiple layers of material that surround at least one insulated conductor 112.

In the illustrated embodiment, the communication cable 100 includes a pair of insulated conductors 112A, 112B. The insulated conductors 112A, 112B may extend parallel to each other along a length of the communication cable 100. As such, the cable configuration shown in FIG. 1 may also be referred to as a parallel pair of conductors. However, the parallel-pair configuration of the communication cable 100 is just one example of the various configurations that the communication cable 100 may have. For example, the insulated conductors may not extend parallel to each other and, instead, may form a twisted pair of insulated conductors. In other embodiments, the communication cable 100 may include only a single insulated conductor or more than two insulated conductors. Moreover, the communication cable 100 may include more than one pair of insulated conductors (e.g., four pairs).

As shown, the communication cable 100 extends along a central or longitudinal axis 190, It is understood that the communication cable 100 is a flexible cable and, as such, the central axis 190 is not required to be linear for an entire length of the communication cable 100. The central axis 190 may extend through a geometric center of a cross-section of the communication cable 100. In the illustrated embodiment, the central axis 190 extends along a tangent line where the insulated conductors 112A, 112B interface or contact each other.

The communication cable 100 may include multiple layers that surround the central axis 190 and the insulated conductors 112A, 112B. For example, the communication cable 100 may include a shielding layer 105 that surrounds the insulated conductors 112A, 112B and a cable jacket 104 that surrounds the shielding layer 105 along an interface 106. In the illustrated embodiment, the shielding layer 105 immediately surrounds the insulated conductors 112A, 112B such that no other layers of material are located between the shielding layer 105 and the insulated conductors 112A, 112B. The shielding layer 105 may be tightly wrapped about the insulated conductors 112A, 112B such that the insulated conductors are unable to move relative to one another. For instance, the insulated conductors 112A, 112B are arranged side-by-side and each is configured to move or flex with the other. However, in alternative embodiments, the shielding layer 105 may be configured to permit some movement of the insulated conductors 112A, 112B relative to each other.

The cable jacket 104 interfaces with the shielding layer 105. In the illustrated embodiment, the cable jacket 104 immediately surrounds the shielding layer 105 such that no other layers of material are located between the cable jacket 104 and the shielding layer 105. The cable jacket 104 may be applied to the shielding layer 105 through a plastic extrusion process. The cable jacket 104 may also be applied to the shielding layer 105 through a spiral wrapping process. In alternative embodiments, additional layers of material may be located between the shielding layer 105 and the insulated conductors 112A, 112B or between the shielding layer 105 and the cable jacket 104.

The shielding layer 105 defines a core cavity 110 that includes the insulated conductors 112A, 112B. In some embodiments, the communication cable 100 does not include a drain wire (also referred to as a grounding or ground wire). In some known cables, a drain wire may extend parallel to the insulated conductors within a core cavity. However, the communication cable 100 shown in FIG. 1 does not include a drain wire in the core cavity 110. Nonetheless, in alternative embodiments, a drain wire may be positioned in the core cavity 110 to extend along the insulated conductors 112A, 112B.

Each of the insulated conductors 112A, 112B includes a wire conductor 130 and an insulation (dielectric) layer 132. The insulation layer 132 surrounds the corresponding wire conductor 130 and electrically separates the wire conductor from the wire conductor of the other insulated conductor. As shown in FIG. 1, the insulated layers 132 of the insulated conductors 112A, 112B have been removed (e.g., stripped) thereby defining an insulation end 134 of the insulated layer 132. The wire conductors 130 extend a distance 136 beyond the corresponding insulation ends 134. In the illustrated embodiment, the insulation ends 134 are substantially flush with a shielding end 122 of the shielding layer 105. However, the insulation ends 134 are not required to be flush with the shielding end 122 in other embodiments.

FIG. 2 is a perspective view of the terminating end 102 of the communication cable 100 in which a portion of the cable jacket 104 has been removed. The cable jacket 104 may be removed using various methods. For example, the cable jacket 104 may be removed thermally, mechanically, or chemically. In particular embodiments, the cable jacket 104 is removed using a laser-ablation operation. During the laser-ablation operation, a laser (e.g., CO₂ laser) is directed onto the cable jacket 104 to thermally remove the material of the cable jacket 104. More specifically, the material of the cable jacket 104 may be burned off. The laser may be moved back and forth across the communicable cable 100 in a raster-like manner.

As shown in the enlarged portion of FIG. 2, the shielding layer 105 may include a dielectric or plastic sub-layer 114 and a conductive material sub-layer 116 (hereinafter referred to as the conductive sub-layer 116). The conductive sub-layer 116 faces away from the insulated conductors 112A, 112B. In some embodiments, the conductive sub-layer 116 is a conductive foil or plating. As such, the configuration shown in FIG. 2 may be referred to as a foil-out configuration. The conductive sub-layer 116 may be resistant to the removal operation. For instance, the laser described above may be incident on the conductive sub-layer 116, but unable to remove the conductive sub-layer 116. By way of example only, the conductive sub-layer 116 may include aluminum. In some embodiments, the conductive sub-layer 116 is applied as a part of a tape or film. The tape or film may have a thickness that is at most about 0.05 inches or, more particularly, at most about 0.01 inches. The conductive sub-layer 116 as part of the tape may have a thickness that is at most about 0.01 inches or, more particularly, at most about 0.001 inches.

As the cable jacket 104 is removed, a jacket end 120 may be formed that is located a longitudinal distance or depth 115 from the shielding end 122 of the shielding layer 105. The jacket end 120 may include a jacket edge 124 indicating where a portion of the cable jacket 104 was removed. The jacket edge 124 may have different characteristics based on the removal process. For example, when the laser-ablation process described above is used to remove a portion of the cable jacket 104, the jacket edge 124 may have characteristics that are different than characteristics formed by mechanically stripping or chemical etching the portion of the cable jacket 104. As such, the jacket edge 124 may be characterized as a “laser-ablated jacket edge,” a “chemically-etched jacket edge,” or “mechanically-removed jacket edge” based on the removal process.

As shown in FIG. 2, the conductive sub-layer 116 includes an electrically conductive exterior surface 118 of the shielding layer 105. For a portion of the communication cable 100 in which the cable jacket 104 has not been removed, the exterior surface 118 may interface with the cable jacket 104. After removing the cable jacket 104, an exposed section 126 of the exterior surface 118 exists. The exposed section 126 extends the distance 115 and extends beyond the jacket end 120 (or the jacket edge 124) to the shielding end 122. The shielding layer 105 is configured to be electrically grounded at the exposed section 126. The insulated conductors 112A, 112B and, more particularly, the wire conductors 130 may clear the shielding edge 122.

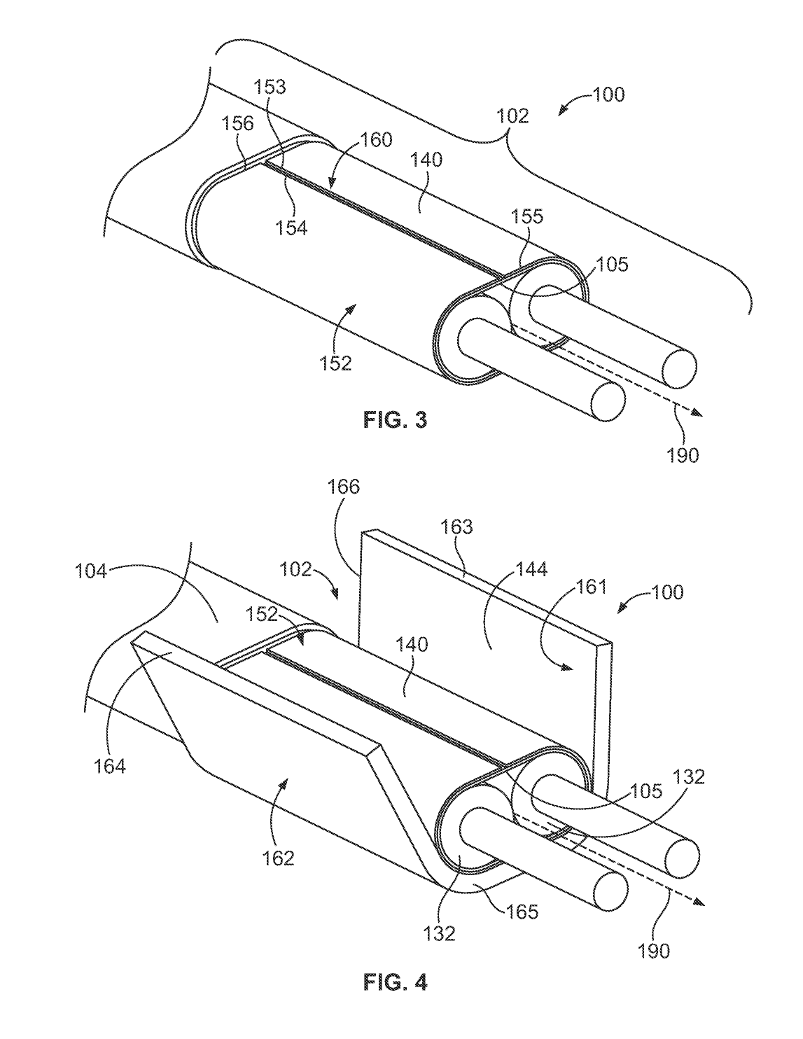

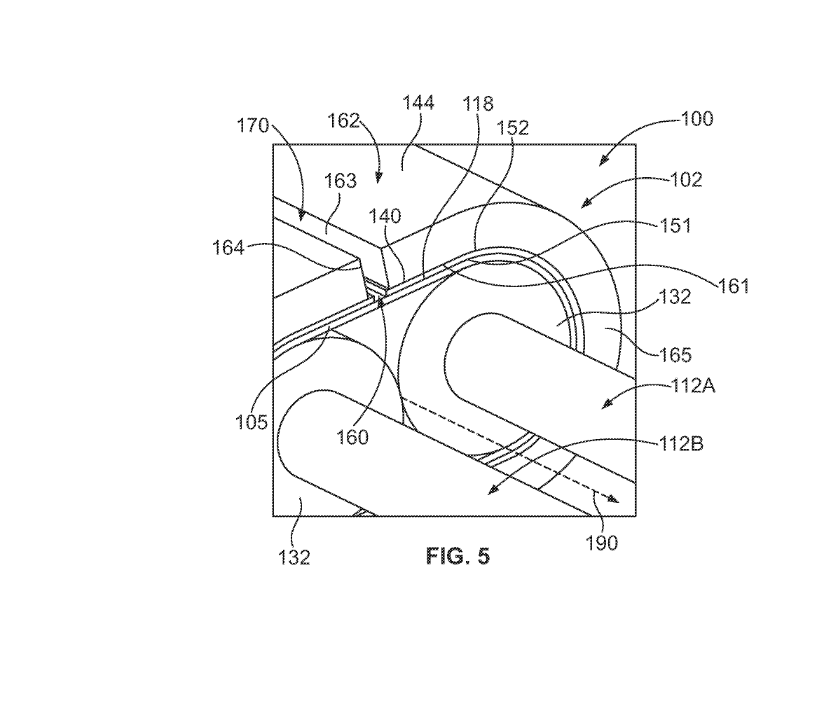

FIG. 3 is a perspective view of the terminating end 102 of the communication cable 100 after an adhesive layer 140 has been coupled to the exposed section 126 (FIG. 2) of the exterior surface 118 (FIG. 2). The adhesive layer 140 may include an adhesive material that is impregnated with conductive particles such that one or more conductive pathways are formed from one side of the adhesive layer 140 to an opposite side of the adhesive layer 140. The adhesive layer 140 may be a band or strip of material having a first side 151 (shown in FIG. 5) and an opposite second side 152. A shape of the adhesive layer 140 may be defined by first and second seam edges 153, 154 and first and second layer or band edges 155, 156 that extend between the first and second seam edges 153, 154. In the illustrated embodiment, the adhesive layer 140 has a uniform thickness, although non-uniform thicknesses may be used. By way of example only, the thickness of the adhesive layer 140 may be about 0.5 to about 5.0 mils or more. In other embodiments, the adhesive layer 140 may not be uniform but, instead, may be thicker or thinner in designated sections of the adhesive layer 140.

During application of the adhesive layer 140, the first side 151 of the adhesive layer 140 may be applied to the exterior surface 118. For example, the first side 151 may be wrapped about the exterior surface 118 such that the first side 151 is also wrapped about the central axis 190. The first side 151 may be applied uniformly across the exterior surface 118 such that bubbles or pockets of air are reduced and the first side 151 is in intimate contact with exterior surface 118. In some embodiments, a tool or machine may be used to apply the adhesive layer 140. After application of the adhesive layer 140, the first and second seam edges 153, 154 may be located adjacent to each other and define a longitudinal seam 160 therebetween. However, in alternative embodiments, the seam edges 153, 154 of the adhesive layer 140 may overlap each other or, alternatively, may be separated from each other by a large gap.

In the illustrated embodiment, only a single adhesive layer 140 is applied to and wrapped continuously about the exterior surface 118. In alternative embodiments, the adhesive layer may include a plurality of sub-sections that are collectively wrapped about the exterior surface. For example, a total of four sub-sections may be applied to the exterior surface 118 in which each sub-section may cover about 25% of the exterior surface 118. In such embodiments, a plurality of longitudinal seams may exist. Furthermore, multiple adhesive layers may be stacked with respect to each other. For example, after the adhesive layer 140 is applied to the exterior surface 118, a second adhesive layer may be applied to the adhesive layer 140. In such an embodiment, each of the stacked adhesive layers may be considered a sub-layer of a composite adhesive layer.

The adhesive material of the adhesive layer 140 may include, by way of example only, an acrylic material, an epoxy material, a thermoset material, a thermoplastic material, or a combination thereof. The conductive particles may be dispersed evenly throughout the adhesive material or may have a designated pattern or pitch in the adhesive material such that the conductive particles are concentrated in separate regions. The conductive particles may include, by way of example only, nickel, gold, silver, copper, aluminum, or a combination thereof.

In some embodiments, the adhesive layer 140 is part of a transfer tape in which the second side 152 of the adhesive layer 140 has a release liner (not shown) that is removed after application of the transfer tape. For instance, the first side 151 of the adhesive layer 140 may be exposed to the ambient environment before the adhesive layer 140 is applied to the exterior surface 118 of the exposed section 126. The second side 152 may include a release liner. After the first side 151 is applied to the exterior surface 118, the release liner may then be removed to expose the second side 152 of the adhesive layer 140. Examples of such transfer tapes include the Electrically Conductive Adhesive Transfer Tape (ECATT) product line developed by 3M™. In other embodiments, the adhesive layer 140 is applied to the exterior surface 118 as a liquid or in an aerosol form. For example, the adhesive layer 140 may be painted, printed, dipped, or sprayed onto the exterior surface 118.

In some embodiments, the adhesive layer 140 circumferentially surrounds the exposed section 126 about the central axis 190. As used herein, the adhesive layer 140 circumferentially surrounds the exposed section 126 of the shielding layer 105 if more than half of the exterior surface 118 in a cross-section taken orthogonal to the central axis 190 is covered by the adhesive layer 140 (or multiple adhesive layers applied to the exterior surface 118). In particular embodiments, the adhesive layer 140 surrounds more than 75% of the exterior surface 118 in the cross-section or, more particularly, more than 90% in the cross-section. In some embodiments, the seam edges 153, 154 may contact each other or may be proximate to each other to form the longitudinal seam 160 between the seam edges 153, 154 as shown in FIG. 3.

FIG. 4 is a perspective view of the terminating end 102 of the communication cable 100 as a ground shield 144 is applied to the terminating end 102, and FIG. 5 is an enlarged view of the terminating end 102 after the ground shield 144 has been applied. The ground shield 144 is configured to surround at least a portion of the terminating end 102 about the central axis 190 and couple to the adhesive layer 140. The ground shield 144 may be formed or shaped (e.g., bent or rolled) to surround the terminating end 102 and be pressed against the second side 152 of the adhesive layer 140. The ground shield 144 may comprise a metallic material that is suitably conductive for allowing a grounding pathway to propagate through the ground shield 144 between the adhesive layer 140 and a portion of an electrical component (not shown), such as an electrical connector. To grip the terminating end 102, the material of the ground shield 144 may be deformed and pressed radially inwardly toward the central axis 190. In some embodiments, the ground shield 144 is sized and shaped similarly to the adhesive layer 140 as shown in FIGS. 4 and 5. For example, the ground shield 144 may have rectangular dimensions. However, a thickness of the ground shield 144 may be significantly greater than the thickness of the adhesive layer 140. Likewise, a thickness of the ground shield 144 may be significantly greater than the thickness of the shielding layer 105. For example, the ground shield 144 may be 10× or more than the thickness of the shielding layer 105.

As shown, the ground shield 144 includes first and second sides 161, 162 having seam edges 163, 164 and ground edges 165, 166 (FIG. 4). Similar to the application process of the adhesive layer 140, the first side 161 of the ground shield 144 may be applied to the second side 152 of the adhesive layer 140. The first side 161 of the ground shield 144 may be wrapped about the second side 152 of the adhesive layer 140 (e.g., wrapped about the central axis 190). The first side 161 may be applied uniformly across the second side 152 such that bubbles or pockets of air are reduced and the first side 161 is in intimate contact with the second side 152.

A tool or machine may be used to apply the ground shield 144. For example, a crimping tool may be configured to shape and press the ground shield 144 against the adhesive layer 140. In particular embodiments, the adhesive layer 140 is a pressure-sensitive adhesive layer in which a curing process is activated by applying a designated amount of pressure or a radially-inward force against the adhesive layer 140. The pressure may be applied through the ground shield 144. By way of example only, the activating pressure of the adhesive layer 140 may be at least 15 psi or 1.0 kg/cm².

However, in other embodiments, the curing process may include thermal activation of the adhesive layer 140. For example, the adhesive layer 140 may be heated to a designated temperature. The designated temperature may be less than a melting point of the other materials of the communication cable 100 (e.g., the insulation layers 132 or the cable jacket 104 (FIG. 4)). In some embodiments, the curing process may include both pressure activation and thermal activation.

Accordingly, the adhesive layer 140 may be in intimate contact with the exterior surface 118 (FIG. 5) along the first side 151 (FIG. 5) and in intimate contact with the ground shield 144 along the second side 152. As such, the adhesive layer 140 may mechanically couple (e.g., bond) the shielding layer 105 and the ground shield 144. The adhesive layer 140 may also provide one or more electrical (or grounding) pathways between the shielding layer 105 and the ground shield 144.

During the lifetime operation of some conventional communication cables, the insulation of the communication cables may deform or change shape. In such embodiments where the conductive foil is supported or held between the dielectric insulation layer 132 and the ground shield 144, dielectric relaxation may negatively affect the electrical connection between the conductive foil and the ground shield 144. However, during the lifetime operation of the communication cable 100, the adhesive layer 140 may operate to maintain the mechanical and electrical connection between the ground shield 144 and the shielding layer 105. If insulating materials (or other materials) of the communication cable 104 change shape, the adhesive layer 140 may maintain the bond between the ground shield 144 and the shielding layer 105. In addition, the adhesive layer 140 may inhibit or impede oxidation along the interface between the ground shield 144 and the exterior surface 118.

As shown in FIG. 5, after application of the ground shield 144, the first and second seam edges 163, 164 may be located adjacent to each other and define a longitudinal seam 170 therebetween. In some embodiments, the seam edges 163, 164 (or portions of the ground shield 144) may overlap each other, or, in other embodiments, the seam edges 163, 164 may be separated from each other by a large gap. In alternative embodiments, the ground shield 144 may be seamless without seam edges 163, 164. As shown in FIG. 5, the longitudinal seams 160, 170 may be aligned with each other such that a collective seam is formed. However, in alternative embodiments, the longitudinal seams 160, 170 may have different non-overlapping locations. For example, the longitudinal seams 160, 170 may be on opposite sides of the communication cable 100. Also shown in FIG. 5, the insulated conductors 112A, 112B may extend beyond the ground edge 165.

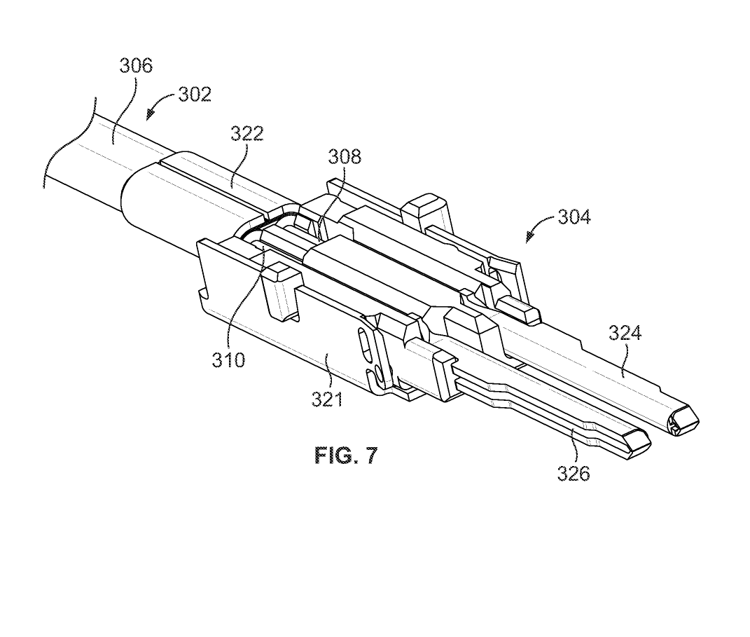

In some embodiments, the ground shield 144 operates as an intermediate shield. Another ground shield (not shown), such as a portion of an electrical connector (not shown), may be shaped to grip the ground shield 144. However, in alternative embodiments, the ground shield 144 may be part of the electrical connector. Such an embodiment is described below with respect to FIG. 7.

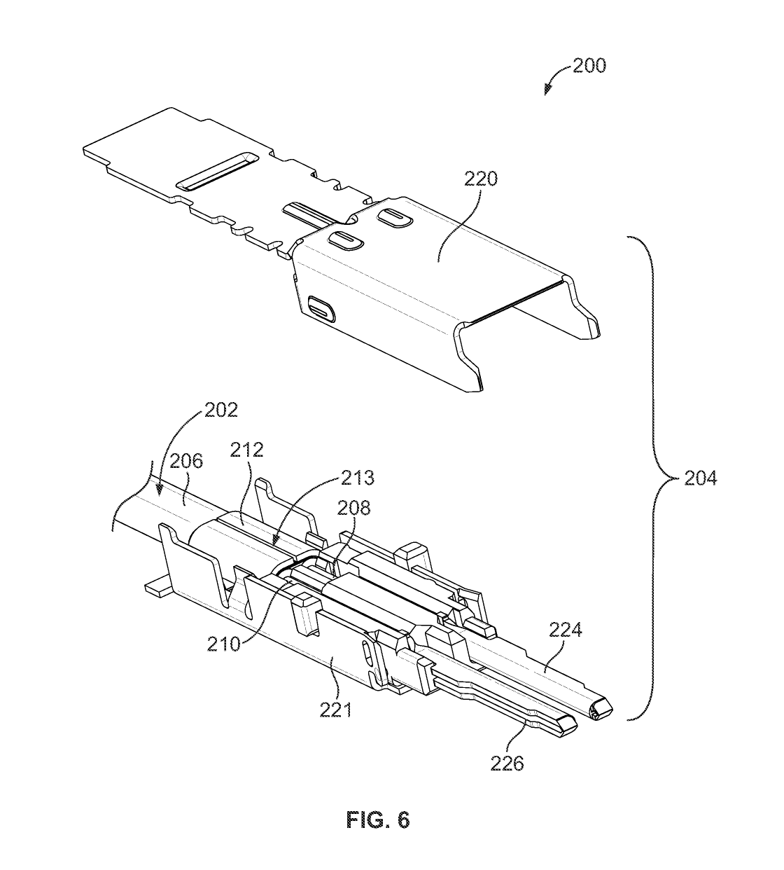

FIG. 6 shows a perspective view of an electrical connector assembly 200 formed in accordance with one embodiment. The connector assembly 200 may include a communication cable 202 and an electrical connector 204. The communication cable 202 may be similar to the communication cable 100 (FIG. 1) and include a cable jacket 206, insulated conductors having wire conductors 208, 210, and a ground shield 212. A longitudinal seam 213 formed by the ground shield 212 is shown in FIG. 6 as well. The ground shield 212 is wrapped about an adhesive layer (not shown) as described above with respect to the communication cable 100. The wire conductors 208, 210 project beyond the ground shield 212.

The electrical connector 204 includes first and second housing shells 220, 221 that are configured to be coupled to each other and signal conductors 224, 226. The first and second housing shells 220, 221 may be mated together to define a contact-space therebetween where the signal conductors 224, 226 and the wire conductors 208, 210 are located. In the illustrated embodiment, the ground shield 212 and at least one of the first or second housing shells 220, 221 are configured to mechanically and electrically couple to one another. For example, either or both of the first and second housing shells 220, 221 may be shaped to surround and be deformed (e.g., crimped) to grip the ground shield 212. In such embodiments, the first and/or second housing shells 220, 221 may be referred to as a connector shield(s), and the ground shield 212 may be referred to as a ferrule or intermediate shield. Before, after, or during the coupling process, the wire conductors 208, 210 may be mechanically and electrically connected to the signal conductors 224, 226, respectively. In other embodiments, at least one of the first or second housing shells 220, 221 is welded to the ground shield 212.

FIG. 7 shows a perspective view of a portion of an electrical connector assembly 300 formed in accordance with one embodiment. The electrical connector assembly 300 may be similar to the connector assembly 200 (FIG. 6). For example, the connector assembly 300 may include a communication cable 302, which may be similar to the communication cables 100 (FIG. 1), 202 (FIG. 6) described above, and an electrical connector 304. The communication cable 302 may include a cable jacket 306, insulated conductors having wire conductors 308, 310, and an adhesive layer (not shown).

The electrical connector 304 may be similar to the electrical connector 204 (FIG. 6) and include a housing shell 321 that forms a ground shield 322. The electrical connector 304 also has signal conductors 324, 326. Although not shown, the electrical connector 304 may include a housing shell that is similar or identical to the housing shell 220 (FIG. 6). In the illustrated embodiment, the ground shield 322 is a part of the housing shell 321 and is configured to directly couple to the adhesive layer of the communication cable 302 thereby establishing a mechanical and electrical connection to the adhesive layer. For example, the ground shield 322 may be shaped to surround and to be deformed (e.g., crimped) to grip the adhesive layer.

In the illustrated embodiment, the ground shield 322 may be similar to the ground shield 144 (FIG. 4) except the ground shield 322 is a part of the electrical connector 304. Before, after, or during the crimping process, the wire conductors 308, 310 may be mechanically and electrically connected to the signal conductors 324, 326, respectively. For example, the wire conductors 308, 310 may be soldered to the signal conductors 324, 326.

In alternative embodiments, the adhesive layer may be applied directly to an interior side of the ground shield 322. In such embodiments, the adhesive layer may engage the exposed section (not shown) of the shielding layer (not shown) as the ground shield 322 is coupled to the communication cable.

In embodiments such as those shown in FIGS. 6 and 7, the corresponding pair of housing shells (e.g., 220, 221) may surround and shield the wire conductors and the signal conductors along an entire length of the housing shells. Accordingly, the connector assemblies 200 and 300 may not have path restrictions (e.g., choke points) like known connector assemblies.

As used herein, an element or step recited in the singular and proceeded with the word “a” or “an” should be understood as not excluding plural of said elements or steps, unless such exclusion is explicitly stated. Furthermore, references to “one embodiment” or “an embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

What is claimed is:

1. A communication cable comprising:
a cable jacket having a jacket end;
a shielding layer having an electrically conductive exterior surface that extends along a length of the communication cable and interfaces with the cable jacket, the exterior surface having an exposed section that extends beyond the jacket end to a shielding end of the shielding layer;
at least one insulated conductor that extends along the length of the communication cable and that is surrounded by the shielding layer and the cable jacket; and
an adhesive layer surrounding the exposed section of the exterior surface, the adhesive layer being electrically conductive and being in intimate contact with the exterior surface.

2. The communication cable of claim 1, wherein the at least one insulated conductor includes a corresponding wire conductor that is surrounded by a corresponding insulation layer, the wire conductor extending beyond the shielding end of the shielding layer.

3. The communication cable of claim 1, further comprising a ground shield in intimate contact with the adhesive layer.

4. The communication cable of claim 3, wherein the ground shield includes a ground edge, the at least one insulated conductor extending beyond the ground edge.

5. The communication cable of claim 3, further comprising a connector shield of an electrical connector, the connector shield being directly coupled to the ground shield.

6. The communication cable of claim 1, wherein the adhesive layer includes an adhesive material that is impregnated with conductive particles.

7. The communication cable of claim 1, wherein the adhesive layer is a pressure-sensitive adhesive layer.

8. The communication cable of claim 1, wherein the cable jacket includes a laser-ablated edge at the jacket end.

9. The communication cable of claim 1, wherein the at least one insulated conductor includes a pair of insulated conductors.

10. The communication cable of claim 9, wherein the insulated conductors extend substantially parallel to each other along the length of the communication cable.

11. The communication cable of claim 1, wherein the communication cable does not include a drain wire that extends along the at least one insulated conductor.

12. A communication cable comprising:
a cable jacket having a jacket end;
a shielding layer having an electrically conductive exterior surface that extends along a length of the communication cable and interfaces with the cable jacket, the exterior surface having an exposed section that extends beyond the jacket end to a shielding end of the shielding layer; and
at least one insulated conductor that extends along the length of the communication cable and that is surrounded by the shielding layer and the cable jacket;
wherein the communication cable does not include a drain wire that extends along the at least one insulated conductor, the shielding layer configured to be electrically grounded at the exposed section.

13. The communication cable of claim 12, further comprising an adhesive layer surrounding the exposed section of the exterior surface, the adhesive layer being electrically conductive and being in intimate contact with the exterior surface of the shielding layer.

14. The communication cable of claim 13, further comprising a ground shield in intimate contact with the adhesive layer.

15. The communication cable of claim 14, wherein the ground shield includes a ground edge, the at least one insulated conductor extending beyond the ground edge.

16. The communication cable of claim 13, wherein the adhesive layer includes an adhesive material that is impregnated with conductive particles.

17. The communication cable of claim 13, wherein the adhesive layer is a pressure-sensitive adhesive layer bonded to the exterior surface of the shielding layer.

18. An electrical connector assembly comprising:
an electrical connector having signal conductors;
a communication cable coupled to the electrical connector, the communication cable comprising:
insulated conductors extending along a length of the communication cable, the insulated conductors being electrically coupled to corresponding signal conductors;
a shielding layer surrounding the insulated conductors and having an electrically conductive exterior surface that extends along the length of the cable; and
an adhesive layer that surrounds and is in intimate contact with the exterior surface of the shielding layer, the adhesive layer being electrically conductive; and
a ground shield surrounding the adhesive layer, wherein the ground shield electrically couples the exterior surface of the shielding layer to the electrical connector such that a grounding pathway exists through the ground shield.

19. The connector assembly of claim 18, wherein the electrical connector includes the ground shield.

20. The connector assembly of claim 18, wherein the ground shield is in intimate contact with the adhesive layer.
